(19) United States
(12) Patent Application Publication
(10) Pub. No.: US 2013/0302870 A1
(43) Pub. Date: Nov. 14, 2013

(54) Flowthrough Pretreatment Of Lignocellulosic Biomass And Selective Separation Of Components Using High-Temperature Nanoporous Membranes

(71) Applicants: Lee R. Lynd, Meriden, NH (US); Chaogong Liu, Lebanon, NH (US); David A. Hogsett, Grantham, NH (US)

(72) Inventors: Lee R. Lynd, Meriden, NH (US); Chaogong Liu, Lebanon, NH (US); David A. Hogsett, Grantham, NH (US)

(73) Assignee: THE TRUSTEES OF DARTMOUTH COLLEGE, Hanover, NH (US)

(21) Appl. No.: 13/704,122

(22) PCT Filed: Jun. 20, 2011
(86) PCT No.: PCT/US11/41097

§ 371 Date: Jul. 25, 2013

Related U.S. Application Data
(60) Provisional application No. 61/386,282, filed on Sep. 24, 2010.
(60) Provisional application No. 61/356,623, filed on Jun. 20, 2010.

(51) Int. Cl. B01D 61/14

(52) U.S. Cl. CPC B01D 61/14
USPC 435/161; 210/196; 210/177; 210/805; 210/774

(57) ABSTRACT

A new and improved biomass conversion system is disclosed using high-temperature flow-though pretreatment and a nanoporous membrane to provide more digestible biomass for subsequent conversion to biofuels.

### RELATED APPLICATIONS

This application claims priority to U.S. Provisional Application No. 61/356,623 filed on Jun. 20, 2010 and to U.S. Provisional Application No. 61/386,282 filed on Sep. 24, 2010. The contents of both of these applications mentioned above are hereby incorporated into this application by reference.

### BACKGROUND

I. Field of the Invention

The disclosure relates to treatment of biomass with high temperature flowthrough to fractionate the biomass components in a manner that increases the yield and quality of solubilized products and produces a high-quality cellulosic material.

II. Description of the Related Art

Biomass is a relatively inexpensive, renewable and abundant material that can be used to generate fuels, chemicals, fibers, and energy. However, large-scale utilization of plant biomass is hindered, at least in part, by the lack of technologies capable of efficiently converting the biomass into component fractions or reactive intermediates at a low cost. For example, most plant biomass is resistant to the digestion by cellulase, which may lead to low cellulose hydrolysis yields.

Pretreatment of biomass may render the biomass more amenable to enzymatic digestion by a combination of not completely understood mechanisms that include removing biomass components such as lignin and/or hemicellulose that impede access to cellulase enzymes, as well as structural changes (e.g. particle size, porosity, surface area). Various biomass pretreatment technologies have been developed. Examples of these developments include use of dilute acids or bases, steam explosion, autohydrolyisis, controlled pH, AFEX, and aqueous ammonia pretreatment.

Autohydrolysis pretreatment employs hot water or steam to pretreat biomass. However, high pretreatment severity (e.g. temperature >190° C.) are generally required to produce digestible substrate which may result in high losses of hemicellulose sugars. For instance, depending on residence time, xylose losses can be greater than 25%, 50% or even higher. In addition, inhibitors released from the biomass and produced in the course of sugar and lignin degradation may negatively affect the qualities of the insoluble materials, such as substrate fennentability and digestibility.

In conventional steam pretreatment in which the residence time of the solids and liquid is the same, whether operated in batch or continuous mode, dissolved biomass components may degrade once they are dissolved or suspended in solution. In addition, solubilized lignin and hemicellulose components may precipitate during cooling, which decreases the reactivity of the biomass to enzymatic hydrolysis.

One approach for improving pretreatment effectiveness involves washing of the solid biomass after closed-system pretreatment (“post-washing”). Post-washing at high temperatures, for example, at 140° C., helps produce reactive biomass material and also removes some lignin and hemicellulose solubilzation products. The amount of lignin and hemicellulose solubilzation products removed in post-washing may not be as much as the amount that would be removed if washing were done at pretreatment reaction temperatures. Furthermore, once-through washing typically dilutes solubilized components, making them more expensive to recover or process in subsequent steps. Although post-washing of solid biomass at moderate temperatures (e.g., 100° C.) and under atmospheric pressure may help eliminate certain complexities, it is not very efficient in producing adequate yield of the biomass solids and makes achieving sterilization more difficult.

Another approach for enhancing pretreatment effectiveness involves flowing hot water, or acid, through the solid biomass, also known as flowthrough pretreatment. Flowthrough pretreatment with hot water, or very dilute acid, may effectively remove hemicellulose and lignin, and may generate highly active substrate (Liu & Wyman, 2003, 2004). For example, hot flowthrough pretreatment removes significant amount of dissolved hemicellulose and lignin thus avoiding precipitation. When flowthrough pretreatment is carried out with hot liquid at a temperature of, for example, between 120° C. and 240° C., the reactivity of the resulting biomass solids are several-fold greater than that of a closed-system control. However, conventional flowthrough operation uses too much energy and water. Moreover, the hemicellulose hydrolyzate recovered from flowthrough pretreatment is dilute which increases the cost of subsequent sugar recovery.

### SUMMARY

The presently disclosed instrumentalities advance the art by providing a system and a process for pretreating biomass to enhance the conversion rate and efficiency from subsequent processing of biomass to biofuels using microbial or enzymatic processing. More particularly, a high-temperature liquid (also referred to as “hot liquid”), such as water or other fluid, may be passed through the biomass to generate a first flowthrough mixture (also referred to as “effluent” or “reactor effluent”) containing the liquid and one or more components of the biomass. This first flowthrough mixture may be directed to a filtering system, which may separate the one or more components from the flowthrough mixture, retaining the one or more components of the biomass on the filter (also referred to as “retentate”) while allowing the rest of the first flowthrough mixture to pass through the filter. This pass-through is referred to as “filtrate,” which may be recycled and directed to the biomass again to extract or solubilize more components from the biomass. The retentate may be recovered from the filter and may be further concentrated before being converted into various products. For instance, the retentate may be subsequently converted into biofuels such as ethanol or other products of interest through chemical, biological processes, or combination thereof.

An improved pretreatment system is provided which may include a container or a vessel, such as a reaction vessel. The terms “container” and “vessel” may be used interchangeably in this disclosure. In one aspect, the reaction vessel has an inlet, an outlet, a filtering means operably connected to the outlet of the reaction vessel and a conveying (or recycling) means operably connected to the inlet of the reaction vessel. The reaction vessel may be used for holding the biomass where the hot liquid flows through and is briefly incubated with the biomass. The inlet may allow for the infusion (or entry) of a liquid into the reaction vessel, and the outlet may allow for the liquid to exit the vessel forming a “first flowthrough mixture.”

The filtering means may be any filtration system that is capable of separating the liquid exiting the reactor into a more concentrated stream containing dissolved organics and a largely or entirely organic-free aqueous stream containing water at a temperature of higher than 100° C., 140° C., or as high as 240° C. In one aspect, the filtering means is a nanoporous filter capable of retaining particles or molecules that are larger than about 1 nm while allowing those that are smaller than about 1 nm to pass through. In another aspect, the filtering means has a pore size of about 5 nm, about 2 nm, or about 1 nm. In one embodiment, the filtering means is capable of sustaining temperature as high as 100° C., or as high as 140° C. In another embodiment, the filtering means is a ceramic membrane. The components (or molecules) of a plant biomass that are likely to dissolve in the pretreatment liquid are, by way of example, pentose and hexose sugars, lignin components, acetic acid, oligosaccharides, polysaccharides, or combinations thereof. Examples of pentoses include but are not limited to xylose and arabinose. In another aspect, the component is a carbohydrate having a molecule weight of less than about 1,000 daltons, or less than about 500 daltons.

For purpose of this disclosure, the mixture that passes through the filtering means is termed “filtrate.” The filtrate may be transported by the conveying means to the inlet of the vessel so that the flowthrough pretreatment may be repeated. In one aspect of this disclosure, the system may include a first heating element located inside the container to help increase the temperature of the liquid-biomass mix inside the container. In another aspect, the system may also have a second heating element located outside the vessel. In another aspect, the second heating element is located upstream of the inlet and may help heating the initial liquid in the first cycle or the recycled filtrate before it enters the vessel.

In another embodiment, a method is disclosed for improving the yield and/or efficiency of biomass conversion into biofuels or other materials. The method may include a step (a) of allowing an effective amount of a liquid to pass through the biomass, wherein at least one component of the biomass forms a first flowthrough mixture with the liquid. The liquid may be water, an aqueous solution, other fluids or solvents and solutions thereof. In one aspect, prior to its first contact with the biomass, the liquid suitable for flowthrough pretreatment has a viscosity similar to water, or less than three times more viscous that liquid water under the same environmental condition.

In another aspect, the biomass may be pre-loaded into a vessel that has at least an inlet and an outlet. In another aspect, the biomass may be loaded together with the pretreatment liquid into the vessel. The inlet allows entry (or infusion) of the liquid into the vessel, while the outlet allows the liquid to exit the vessel after it flows through the biomass inside the vessel. The inlet and the outlet may be the same opening on the wall of the vessel. Preferably, the inlet and the outlet are different openings on the wall of the vessel. As the liquid flows through the vessel, it may interact physically and chemically with the biomass. One or more components of the biomass may be dissolved at least partially or otherwise brought into the liquid as a result of these interactions. These components may form a solution, a suspension or other forms of mixture with the liquid, which is termed the “first flowthrough mixture.”

The flowing rate of the liquid through the biomass may be adjusted such that the liquid may have long enough time to be incubated with the biomass but not too long to cause degradation of the solubilized components of the biomass. In one aspect, the clearing time for the liquid from entry to exiting the vessel may be between ten seconds and ten minutes.

The temperature and pressure of the flow through liquid may also be regulated. The temperature of the liquid may be adjusted before the liquid enters the vessel. Alternatively, the vessel may have a heating element to heat the liquid as well as the biomass. The vessel may be an open system that is open to the air. Alternatively, the vessel may be a closed system whose pressure may be controlled. The amount of the liquid is an amount that is from 50% to 300% (v/v) of the biomass. Preferably, the effective amount of the liquid is an amount sufficient to cover the biomass.

In another aspect, the first flowthrough mixture is allowed to pass through a filtering system, wherein more than 30%, 50%, 70%, or more preferably more than 90% by weight of the at least one component in the first flowthrough mixture is retained by the filter. The rest of the first flowthrough mixture that is not retained by the filter may pass through the filter forming a “filtrate.” The filtrate may then flow back to the inlet of the container and pass through the biomass again. The recycling pretreatment process described above may be repeated for many cycles until all components of the biomass that can be solubilized in the liquid have been solubilized. Preferably, the pretreatment process may be repeated for n cycles, wherein n is an integer between 1 and 1,000, or preferably between 1 and 100, more preferably between 1 and 50, or even more preferably, for 1-10 cycles.

In an embodiment, during each repeating cycle, the temperature of the liquid may be raised by at least 1° C., by at least 2° C. to 5° C., or more preferably, by at least 5° C. to 10° C., as compared to the liquid in the cycle immediately prior to the current repeating cycle. As the temperature of the flowthrough liquid-biomass gradually rises, different components of the biomass that have different solubility in the hot liquid at different temperature dissolve in the liquid at different time points. These components may, in turn, be retained by the downstream filtering system at different time points. Thus, the presently disclosed methods and systems allow for fractional recovery of different components by gradually increasing the pretreatment temperature. In another aspect, the temperature of the liquid-biomass mix in the container is in the range of between 120° C. and 240° C.

### BRIEF DESCRIPTION OF THE FIGURES

FIG. 1 illustrates the general concept of a system for flowthrough pretreatment of biomass.

FIG. 2 illustrates one design of a flowthrough pretreatment system.

FIG. 3 compares the advantages and disadvantages of various pretreatment configurations.

FIG. 4 shows fractionation of solubilized components recovered at different temperatures.

FIG. 5 shows fractionation of solubilized arabinose and glucose recovered at different temperatures along with the temperature under which the pretreatment was performed.

FIG. 6 shows fractionation of solubilized xylose recovered at different temperatures along with the temperature under which the pretreatment was performed.

FIG. 7 shows flow-through pretreatment of solid biomass using multiple filters.

FIG. 8 shows a flow-through pretreatment system with integrated heat recovery.

FIG. 9 shows a flow-through pretreatment system with integrated heat recovery.

FIG. 10 shows a flow-through pretreatment using multiple biomass containers, or biomass beds.

FIG. 11 shows flow-through pretreatment using an intermediate processing vessel.

### DETAILED DESCRIPTION

The present disclosure relates to biomass pretreatment using a high-temperature flow-through process and one or more nanoporous membranes to provide an improved, selective separation of biomass components, improved hemicellulose recovery, and improved cellulose digestibility. As used herein, “flow-through” or “flowthrough” refers to a process wherein a liquid is added to a solid or a semi-solid material and is incubated with the material for a period of time before leaving the solid or semi-solid material. During the course of the flow-through, the liquid may solubilize, extract or otherwise bring along certain components of the biomass. In a preferred embodiment, the temperature of the flow-through liquid is at least 120° C.; or more preferably, at least 140° C.

The term “biomass” refers to non-fossilized renewable materials that are derived from or produced by living organisms. In its broadest term, biomass may include animal biomass, plant biomass, and human waste and recycled materials, among others. Examples of animal biomass may include animal by-product and animal waste, etc. In a preferred embodiment of this disclosure, biomass refers to plant biomass which includes any plant-derived matter (woody or non-woody) that is available on a sustainable basis. Plant biomass may include, but is not limited to, agricultural crop wastes and residues such as corn stover, wheat straw, rice straw, sugar cane bagasse and the like, grass crops, such as switch grass and the like. Plant biomass may further include, but is not limited to, woody energy crops, wood wastes and residues such as trees, softwood forest thinnings, barky wastes, sawdust, paper and pulp industry residues or waste streams, wood fiber, and the like. In urban areas, plant biomass may include yard waste, such as grass clippings, leaves, tree clippings, brush, etc., vegetable processing waste, as well as recycled cardboard and paper products.

The terms “reaction vessel,” “biomass container,” and “pretreatment reactor” may be used interchangeably in this disclosure.

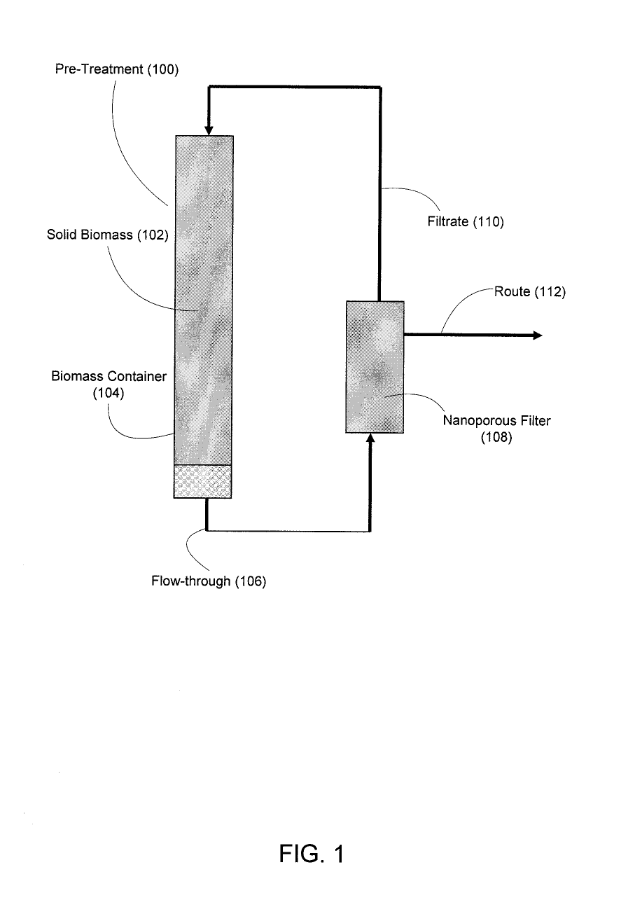

FIG. 1 shows by way of example the general concept of biomass recovery and separation via flow-though pretreatment and high-temperature nanoporous membrane. FIG. 1 shows pretreatment 100 of solid biomass 102, wherein hot water flows through solid biomass material 102 that is present in a reaction vessel 104. Flow-through liquid 106 is a liquid mixture, containing water and solubilized biomass component(s), that exits the reaction vessel 104. Flow-though liquid 106 is directed to nanoporous filter 108. Nanoporous filter 108 retains a portion of solubilized biomass components from the flow-though liquid 106 and elutes the remainder of the flow-through liquid 106. Filtrate 110 exits nanoporous filter 108 and is directed to biomass reaction vessel 104. Direction of filtrate 110 to reaction vessel 104 recycles the flow-through liquid 106. Concentrated solubilized components retained on filter 108 can be further directed via route 112 to processes involving biomass hydrolysis, fermentation, ethanol collection or combination thereof.

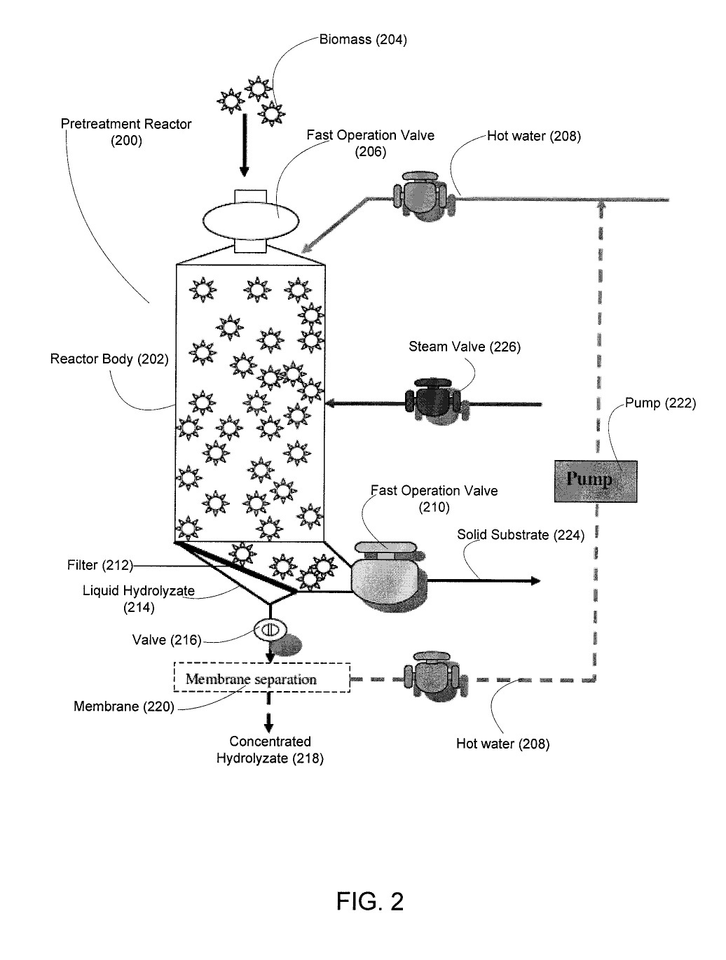

FIG. 2 shows an example of biomass recovery and separation via flow-though pretreatment and high-temperature nanoporous membrane. Pretreatment reactor 200 contains a reactor body 202. Biomass 204 is loaded into pretreatment reactor 200 using fast-operation valve 206. Hot water 208 flows through biomass 204 located within reactor body 202. In one embodiment, hot water 208 originates from a boiler and is under high-pressure. Solid pretreated biomass is discharged from pretreatment reactor 200 using fast-operation valve 210. Filter 212 is located inside and at the bottom of reactor body 202. Filter 212 is positioned at a particular slope to permit rapid liquid separation and easy solid discharge. In one embodiment, the filter is positioned at a slope greater than 90° relative to the reactor body. In one embodiment, high-pressure hot-water, between 120° C. and 230° C., continuously or intermittently flows through biomass 204 located within pretreatment reactor 200 to remove the majority of hemicellulose and lignin. In one embodiment, biomass 204 is feedstock. After flowthrough, liquid hydrolyzate 214 is released through valve 216. In one example, liquid hydrolyzate 214 contains hot liquid hemicellulose hydrolyzate. Liquid hydroylzate 214 from the flowthrough forms concentrated hydrolyzate 218 after passing through a high temperature-resistant membrane 220. Hot water 208 exiting the membrane separation is recycled and reused to significantly reduce water consumption and energy cost in flowthrough operations. Pump 222 assists in recycling hot water 208 exiting membrane 220 to reactor body 202. In one embodiment, hot water 208 that exits membrane 220 contains less than 50% of the biomass present in liquid hydrolyzate 214. Solid substrate 224 is discharged from fast operation valve 210. If desired, solid substrate 224 may be pretreated again with steam, with or without addition of chemicals, followed by steam explosion, from steam valve 226, to reduce substrate particle size.

The present instrumentalities provide an improved method for low cost biomass recovery using flow-though pretreatment, high-temperature separation, and subsequent liquid recycle. Advantageously, a variety of factors facilitate the improved biomass pretreatment, separation of solubilized components in concentrated form, and minimization of degradation and inhibitor formation by removing solubilized components more quickly than would occur in a reactor without flow through pretreament. Other advantages include, for example, the ease of liquid movement through the solids bed during high pretreatment temperatures, low flow-through liquid viscosity, and elevated dissolution of solid biomass, minimal biomass degradation, and compliance with sterilization conditions. Various factors of the present instrumentalities permit ease of liquid movement during treatment of solid biomass including low flow-through liquid viscosity, ability of liquid to flow-though large particle sizes of pretreated biomass, and substantial dissolution of biomass. For instance, the liquid flowing through the biomass at 200° C. may have a viscosity that is half of the viscosity of a liquid flowing through the biomass at 100° C. In another nonlimiting example, dissolution of biomass, occurring at pretreatment temperatures ≧200° C., reduces the quantity of solid biomass material through which water moves.

In another aspect, the disclosed systems and methods may also help reduce water consumption and energy cost by using membranes that can withstand high temperature to separate soluble biomass and recycle hot water at pretreatment temperatures. In one embodiment, improved hemicellulose recovery and improved lignin removal is permitted by performing functions such as flowthrough, steam explosion, hot washing, running batch, or combinations thereof. The present disclosure may generate more digestible and fermentable substrates by performing pretreatment flowthrough followed by steam explosion pretreatment, with or without the addition of chemicals.

The present instrumentalities provide a reiterative pretreatment process that significantly increases hemicellulose recovery and cellulose digestibility. The present reiterative pretreatment process may involve an initial flowthrough pretreatment of biomass, within a reaction vessel to generate a first flowthrough liquid mixture that contains one or more dissolved components originating from the biomass. The reactor effluent is concentrated after passing through a high-temperature resistant membrane. For example, hot dilute hemicellulose hydrolyzate from flowthrough operation is concentrated by using a high-temperature resistant nanoporous ceramic membrane. In one embodiment, the first flowthrough pretreatment of lignocellulosic biomass removes the majority of hemicellulose and lignin. The present reiterative pretreatment process may also involve a second flowthrough pretreatment of biomass with steam, followed by steam explosion to reduce biomass particle size. A second flowthrough pretreatment of biomass with steam may occur with or without any chemicals. Advantageously, the first flowthrough pretreatment and the second and subsequent flowthrough pretreatment may occur within the same reactor and may be repeated for several cycles, such as, repeated for 1-50 cycles, more preferably for 1-20 cycles, or even more preferably, for 1-10 cycles.

The presently disclosed system may include a nanoporous membrane for selective separation of biomass component(s) from flow-through liquid (or mixture). Nanoporous membranes with precise pore sizes advantageously provides a cost-effective approach for high throughput biomass separation from flow-though liquid. Nonlimiting examples of nanoporous inorganic filter material include ceramics and scintered metal. Nonlimiting examples of ceramic materials include alumina, silica, and titania. Nanoporous membranes selectively retain certain lignocellulosic materials while simultaneously eluting the remainder of the flow-through liquid. In one embodiment, a nanoporous membrane filter retains pentose sugars from a flow-though liquid while permitting the passage of acetic acid and dissolved salts. In another embodiment, a nanoporous membrane filter retains molecules selected from pentose, lignin, oligosaccharides, polysaccharides, or combinations thereof. In one embodiment, the flow-through liquid is subject to reverse osmosis and the filtrate is directed to the solid biomass in a recycling process.

Nanoporous membranes of the present disclosure are resistant to high temperatures and pressures. In one embodiment, a nanoporous membrane filter operates at temperatures ≧300° C. and at pressures ≧250 psi. In another embodiment, a nanoporous filter contains pore sizes less than 2 nm and a molecular weight cutoff value of 400 Da. Nanoporous membranes may also include reverse osmosis (RO) membranes. RO membranes provide high flux and high throughput with ease of maintenance and minimal fouling. In one embodiment, a RO membrane tolerates pressures ≧1000 psi.

In one embodiment, the temperature of a biomass bed may be gradually raised to permit recovery of different biomass fractions. Solubilized biomass components are fractionated by progressively increasing the temperature and recycling the flowthrough mixture by directing the mixture, which exits the temperature-resistant membrane, back to the biomass, which is located within the reactor body. Biomass components with differing dissolution temperatures are recovered as discrete fractions with minimal degradation or dilution. By way of example, gradually increasing the temperature of the water flowing through a biomass bed results in generation of a plurality of fractions, each fraction separately recoverable from the nanoporous membrane. In one embodiment, a fraction recovered from the nanoporous membrane contains a protein.

Besides temperature, other physical and/or chemical properties of the flow-through liquid may be altered between cycles. For instance, the pH or the salt concentration may be changed after a flowthrough cycle. In one aspect, certain amount of an acid may be added to the filtrate such that the pH of the filtrate to be recycled to the biomass decrease by 0.1 pH unit, or more preferably by 0.2 pH unit before being applied to the biomass again. In another aspect, a hot liquid containing no acid may be slowly passed through the biomass until some portion of the hemicellulose is released. Then the acid level of the filtrate may be steadily increased to help release additional hemicellulose or open up the structure of the cellulose. The increase in the acid level is gradual such that the acid level increases by 0.01%, 0.1%, or 1% between two contiguous cycles.

In one aspect of the present disclosure, concentrated hemicellulose hydrolyzate and C5 and C6 oligosaccharides may be recovered and used for producing ethanol and other products. In another aspect, the disclosed methods permit scaling up of biomass pretreatment, recovery and separation. Lignin may also be recovered according to the disclosed methods and used in the manufacture of many commercial products. Lignin may be used as an emulsifying, sequestering, binding, or dispersal agent in various industries. Examples of the commercial application of lignin include but are not limited to construction and building materials, special chemicals, paints, and so on. For review, see “Methods in Lignin Chemistry,” (Springer, 1992), and Lora, J., & Glasser, W. “Recent Industrial Applications of Lignin: A Sustainable Alternative to Nonrenewable Materials,” Journal of Polymers and the Environment. 10(1), 39-48 (2002). which are hereby incorporated by reference into this disclosure.

In another embodiment, flashing liquid rich in organics exiting the separator may facilitate heat recovery and may help concentrate organic stream.

In another embodiment, the flow-through pretreatment system may employ multiple filters and multiple flow paths for filtration. Multiple filtration modules may improve separation of compounds released from cellulosic biomass. Multiple passes may allow concentration of soluble components and may help improve filtration performance. Multiple passes may also help reduce water usage and energy consumption.

In one embodiment, a filter bypass may be included during flow-through pretreatment to enable fluid or a portion thereof to make multiple passes through the cellulosic biomass before passing through the filter. It is to be recognized that the number of filer bypass to achieve the highest pretreatment efficiencies depends on a number of factors. These factors may include but are not limited to the nature of the cellulosic materials, the chemistries, temperatures and other operating parameters of the pretreatment system. In order to achieve the highest pretreatment efficiencies, these factors may be adjusted to optimize the conditions for flow-through pretreatment using multiple filters.

In another embodiment, the flow-through pretreatment system of the present disclosure may employ an integrated heat recovery mechanism to reduce energy consumption. Utilization of integrated heat exchangers may facilitate heat capture from heat that would otherwise exit the system. The captured heat may then be transferred to the liquid entering the system. The integrated heat exchangers may be operated at a temperature and pressure required for cellulosic biomass pretreatment. In another aspect, heat capture and reuse is achieved by flashing the fluid leaving the system and transferring heat given off in that process to the incoming fluid stream. In another aspect, the integrated heat recovery may include other means for counter-current heat exchange between hot exiting streams and cold entering streams. In one aspect, the system may contain a heat exchanging means that is capable of recovering heat from liquid exiting the system and providing the recovered heat to liquid entering the reactor vessel. The exiting liquid may be flashed from reaction pressure to atmospheric pressure and the resultant steam may be recovered and may be used to heat any liquid entering the vessel.

In another embodiment, the flow-through pretreatment system may include multiple pretreatment reaction vessels, which may result in more efficient biomass processing. For instance, utilization of multiple reaction vessels may allow loading or unloading of one reaction vessel while another reaction vessel is being processed.

In another embodiment, the flow-through pretreatment system may employ an intermediate processing vessel. For example, an intermediate vessel may be used to facilitate tangential flow filtration (TFF). Utilization of an intermediate vessel and TFF may improve filtration effectiveness and help reduce clogging of filter elements. Improvements via an intermediate vessel and TFF may occur by passing fluid rapidly across a filtration element and may enable greater tangential flux as compared to flux through a filter. With an intermediate vessel to hold flow-through liquid, TFF may be employed to extend filter life. Another advantage of an intermediate vessel and TFF is the potential increase in the concentration of soluble molecules in the filter retentate. The higher concentration of soluble molecules in the retentate means that less fluid exits the system for a given amount of these soluble components, thereby reducing both water usage and energy consumption.

It is to be understood that maintaining liquid at elevated temperature and pressure with intermediate vessel and TFF may result in chemical reactions. For instance, many types of reactions may occur including chemical reaction that may potentially increase or decrease overall process performance. In one aspect, holding the liquid within an intermediate vessel may allow for polymerization or depolymerization of soluble molecules. Other reactions may also impact filtration performance, separation efficiency, and overall process performance. An optimal configuration and processing method may exist for a given biomass and a given pretreatment objective.

### Example 1

### Improved Biomass Recovery Using High-Temperature Flow-Through Pretreatment and Nanoporous Membrane

The following nonlimiting example teaches by way of illustration, not by limitation, a process for improved, selective separation of biomass using high-temperature flow-through pretreatment and nanoporous membrane. Biomass is loaded into a container located within a custom designed bioreactor. A variety of solid biomass may be used, including green waste, such as yard waste, tree clippings, hedge trimmings, plants, and corn stover. Additionally, biomass including brown waste, such as bark, twigs, paper, and cardboard may also be used. Alternatively, herbaceous or woody cellulosic crops may be used.

For the flow-through pretreatment, water, at a temperature of 90° C., is allowed to flow into the biomass container, which holds the solid biomass prepared as described above. The speed by which the hot water flow through the biomass container may be regulated by controlling the inlet and outlet of the biomass container. The biomass container is equipped with a heating element to increase the temperature of the content within the container. Alternatively, heat is supplied by injected steam. As the water flows through the biomass in the reaction vessel, both the water and the biomass are heated and their temperature rises gradually. As the temperature of the water and the biomass continues to rise, different components of the biomass are dissolved in the hot water or may otherwise find their way into the hot water, thus forming a mixture of water and dissolved biomass components.

Because different components of the biomass may have different physical and chemical properties (e.g., solubility, boiling point, etc), different components may be separated from the biomass and form a mixture with the water at different temperatures. As the hot water exits the biomass, the hot water is routed through a filter. The filter may be positioned inside or outside the biomass container.

To test the effectiveness of different filters to retain desirable molecules, the mixture of water and biomass components (also referred to as the eluate) is sampled before and after passing through a variety of filters.

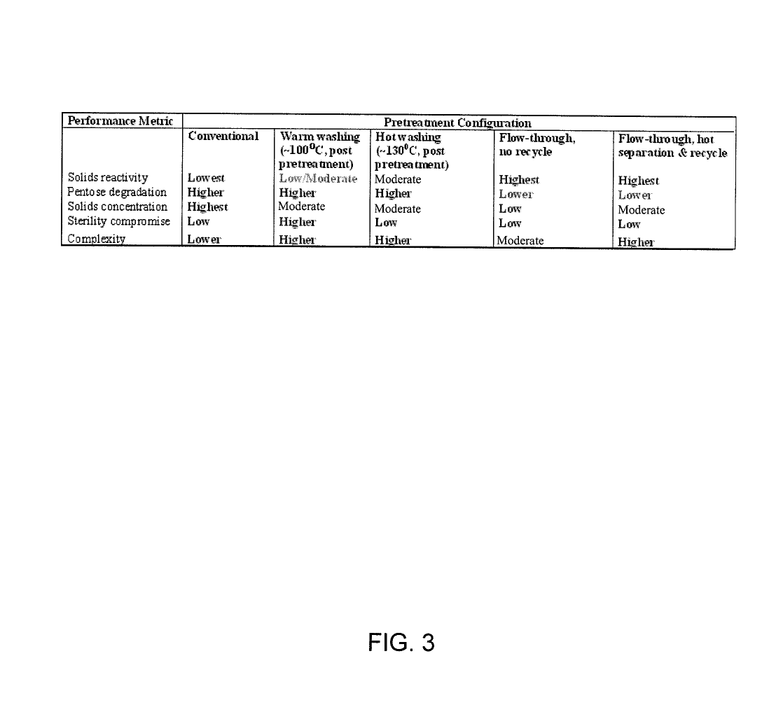

In one test, the eluate is filtered using a nanoporous ceramic filter (Synkera Technologies) with pore diameters of <2 nm at a temperature between 200° C. and 220° C. and at a pressure between 150 psi and 300 psi. In another test, the mixture is filtered using a nanoporous silica filter with pore diameters of <2 nm at a temperature between 200° C. and 220° C. and at a pressure between 150 psi and 300 psi. After filtration, the eluate composition is chemically characterized using a variety of techniques. For example, thin layer chromatography (TLC) (Aldrich) is performed on the eluate using a solvent composition including acetone-ethyl acetate-acetic acid in a 2:1:1 volume ratio and subsequently visualized using a solvent composition including a 1:1 volume ratio of 0.2% methnaolic acid and 20% sulfuric acid. As illustrated in FIG. 3, flow-through with hot separation and recycle contains less pentose degradation, as compared to conventional closed-system pretreatment. FIG. 3 also shows that the reactivity of solids using flow-through with hot separation and recycle is higher as compared to conventional closed-system pretreatment.

In another test, the concentration of solids within the eluate is evaluated using liquid chromatography. As shown in FIG. 3, the concentration of solids is higher for the process involving flow-through pretreatment with hot separation and recycle as compared to flow-through pretreatment with no recycle.

### Example 2

### Improved Carbohydrate Recovery from Corn Stover Using Flowthrough Pretreatment with Hot Separatation and Recycle

The following nonlimiting example teaches by way of illustration, not by limitation, a process for improved, carbohydrate recovery from corn stover using flow-through pretreatment with hot separation and recycle. This nonlimiting example demonstrates advantages for carbohydrate recovery such as preparation of highly reactive solids, minimization of sugar degradation and inhibition, reduction in energy requirements, and minimization of sugar dilution.

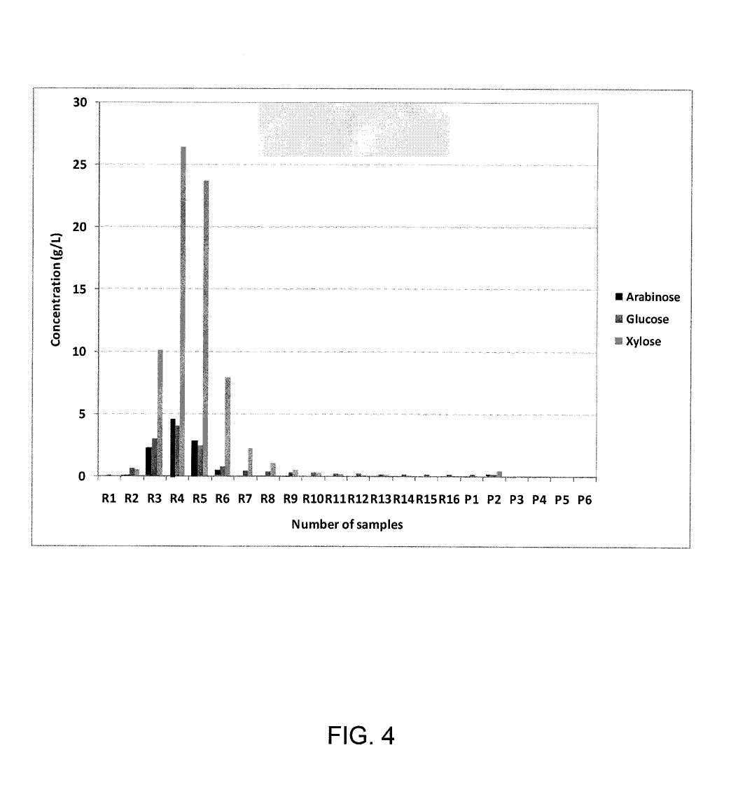

Corn stover was prepared and loaded into a reactor body located within a custom pretreatment reactor. For the flow-through pretreatment, hot water at 95° C. was allowed to enter the reactor vessel and to solubilize a portion of the biomass to produce a liquid hydrolyzate. The liquid hydrolyzate was directed through a ceramic membrane, where most solubilized carbohydrate was retained by the membrane until elution, which generated concentrated liquid hydrolyzate. The hot liquidexiting the ceramic membrane was recycled to the reaction vessel. The temperature of the hot liquid was increased by 5° C. prior to re-entry into the reactor vessel for the second flowthrough. This process, namely reiterative flowthrough pretreatments of corn stover at progressively increasing temperature at an increment of 5° C. per cycle and subsequent membrane elution, was performed for 22 cycles. FIG. 4 shows fractionation of solubilized components released at different temperatures. For example, FIG. 4 demonstrates recovery of xylose between approximately 7.5 g/L and approximately 26 g/L at fractions R3 through R6. Other carbohydrates recovered include arabinose and glucose.

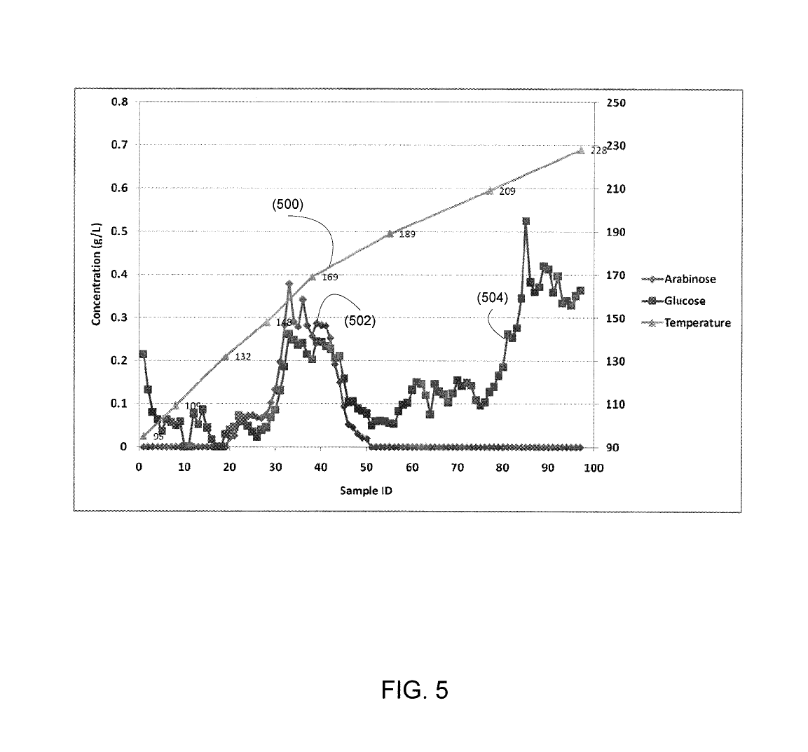

FIG. 5 shows the results of another test for assessing carbohydrate recovery from corn stover using flowthrough pretreatment with hot separation and recycle. The carbohydrate recovery process, involving reiterative flowthrough pretreatment of corn stover at progressively increasing temperature at an increment of 2° C. and subsequent membrane elution using a nanoporous ceramic membrane, as described above, was performed about 100 times. Curve 500 shows the flowthrough water temperature for each eluted fraction collected from the nanoporous ceramic membrane. FIG. 5 shows that fractions collected within the temperature range from 95° C. to 228 C. Curve 502 shows the concentration of arabinose present in each sample fraction. Curve 504 shows the concentration of glucose present in each sample fraction. Slight solubilization of arabinose occurred at 132° C. and about equal solubilization of arabinose occurred at 148° C. and 169° C. No solubilization of arabinose occurred at 189° C. Glucose was solubilized as two separate peaks, one at the temperature range of 145-175° C., the other between 209° C. and 228° C.

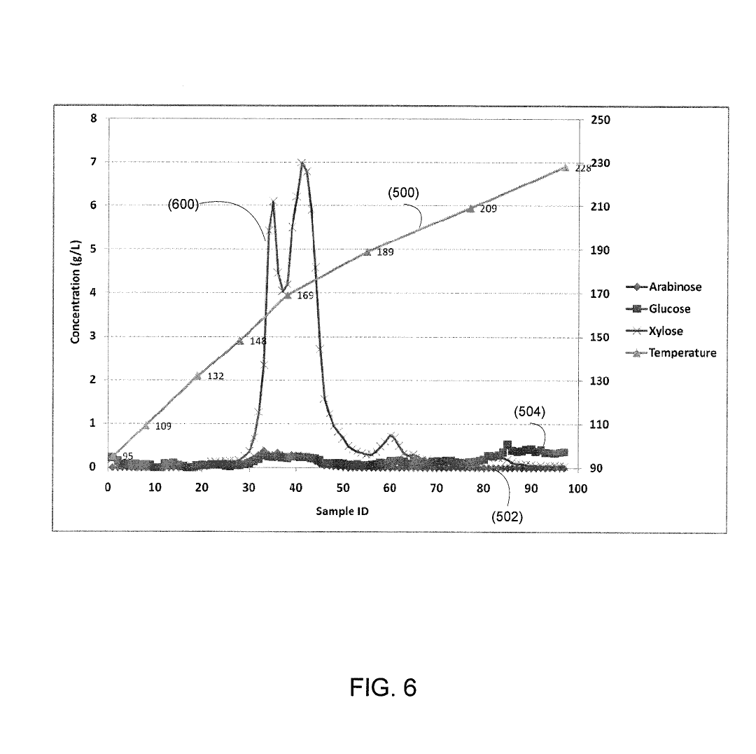

FIG. 6 demonstrates the concentration of xylose present in each sample fraction. For example, xylose recovery reached a concentration of about 7 g/L. FIG. 6 shows that no xylose is released at 132° C. and the majority of xylose is released between 150° C. and 180° C.

### Example 3

### Improved Biomass Recovery Using Multiple Flow Paths for Filtration

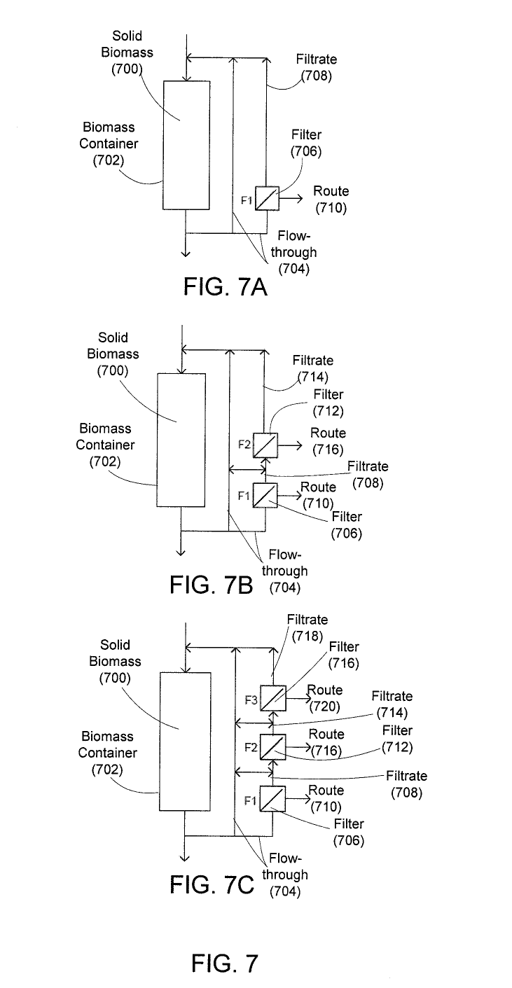

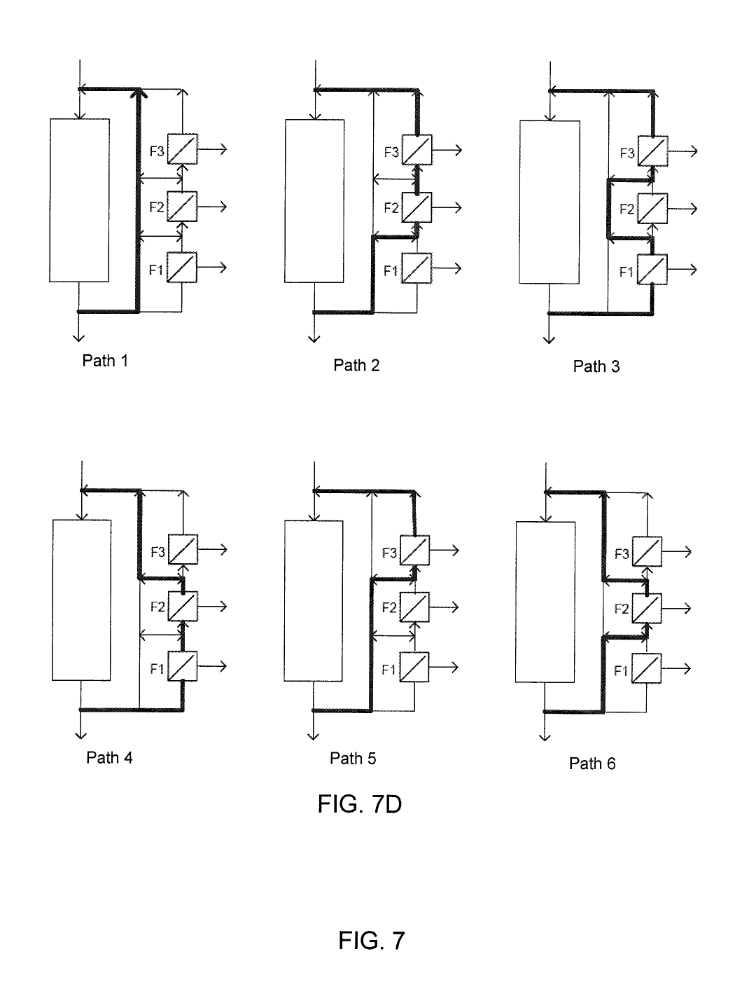

The following nonlimiting example teaches by way of illustration, not by limitation, a process for improved filtration performance using flow-through pretreatment with multiple flow paths for filtration. Utilizing more than one filtration module improves separation of compounds released from cellulosic biomass. FIG. 7 shows flow-through pretreatment of solid biomass. FIG. 7A shows hot water flowing through solid biomass 700 that is present in pretreatment reaction vessel 702. Flow-through liquid 704 is a liquid mixture, containing water and solubilized biomass component(s), which exits the biomass container 702. In one aspect, flow-though liquid (also termed “reactor effluent”) 704 is directed to filter 706. Filter 706 retains a portion of dissolved components originating from biomass from the reactor effluent 704 and elutes the remainder of the flow-through liquid 704. Filtrate 708 exits filter 706 and is directed to biomass container 702. Components retained on filter 706 may be collected via route 710. In another aspect, flow-through liquid 704 bypasses filter 706 and recycles to biomass container 702.

FIG. 7B shows flow-through pretreatment with two filters. In one aspect, filtrate 708 is directed to filter 712. Components retained on filter 712 may be collected via route 716. Filtrate 714 exits filter 712 and is recycled to biomass container 702. In another aspect, filtrate 708 bypasses filter 712 and recycles to biomass container 702.

FIG. 7C shows flow-through pretreatment with three filters. In one aspect, filtrate 714 is directed to filter 716. Components retained on filter 716 may be collected via route 720. Filtrate 718 exits filter 716 and is recycled to biomass container 702. In another aspect, filtrate 714 bypasses filter 716 and recycles to biomass container 702.

In one embodiment, multiple filters present on a pre-treatment system are not all used simultaneously. The multiple filters are used in and out of the flow stream as appropriate for the circumstances and objective. The use of multiple filters enables modification of filtration strategy with appropriate control of flow paths. Multiple filters offer flexibility in choosing which components of the fluid stream are effectively separated by the filtration element(s). This enables improved control over the separation process and may extend filter life. In one embodiment, two soluble components, which differ in molecular weight or charge, are selectively removed into individual exiting streams. In another embodiment, the attributes of the fluid changes over time facilitating the use of different filters at different times during the processing of the cellulosic biomass. In another embodiment, identical filters are used in the same pre-treatment system design to permit switching between filters, which is useful as filter performance deteriorates and filter elements need to be serviced or replaced.

FIG. 7D shows various representative fluid paths using a flow-through pretreatment system with three filters. In FIG. 7D, Path 1 shows a filter bypass, Path 2 shows bypass of filter F1, Path 3 shows bypass of filter F2, Path 4 shows filter bypass of filter F3, Path 5 shows bypass of filters F1 and F2, and Path 6 shows bypass of filter F1 and F3.

### Example 4

### Improved Biomass Recovery Using Integrated Heat Recovery

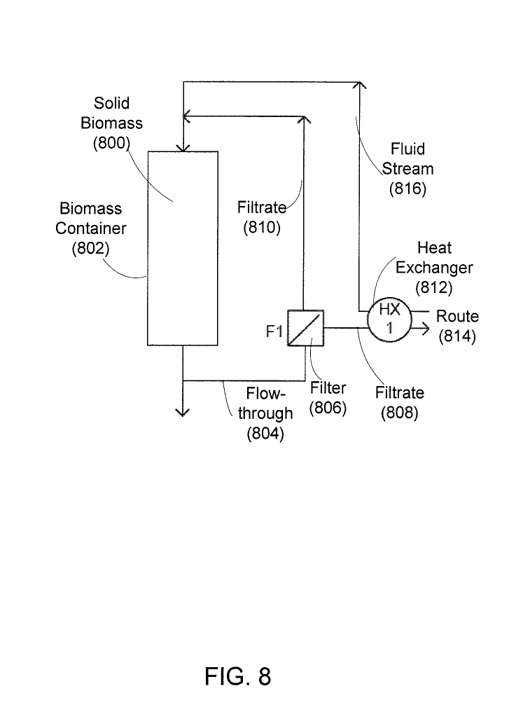

The following nonlimiting example teaches by way of illustration, not by limitation, a process for improving biomass recovery using integrated heat recovery. Key advantages of flow-through pretreatment with recycle are reduced energy costs and reduced water usage. The energy savings are increased with the use of heat exchangers on the process inlets and outlets. FIG. 8 shows a flow-through pretreatment system with integrated heat recovery wherein a liquid/liquid heat exchanger is employed to capture heat that would otherwise exit the system and transfer it to the liquid entering the system.

FIG. 8 shows liquid flowing through solid biomass 800 that is present in a pretreatment reaction vessel 802. Flow-through liquid 804 is a liquid mixture, containing water and solubilized biomass component(s), that exits the pretreatment reaction vessel 802. In one aspect, flow-though liquid 804 is directed to filter 806. Filter 806 retains a portion of biomass from the flow-though liquid 804 and elutes the remainder of the flow-through liquid 804. In another aspect, filtrate 808 is directed to heat exchanger 812. After passing through heat exchanger 812, filtrate 808 exchanges heat with incoming fluid stream 816. Fluid stream 816 is directed to biomass container 802. Also, components retained on filter 808 may be collected via route 814.

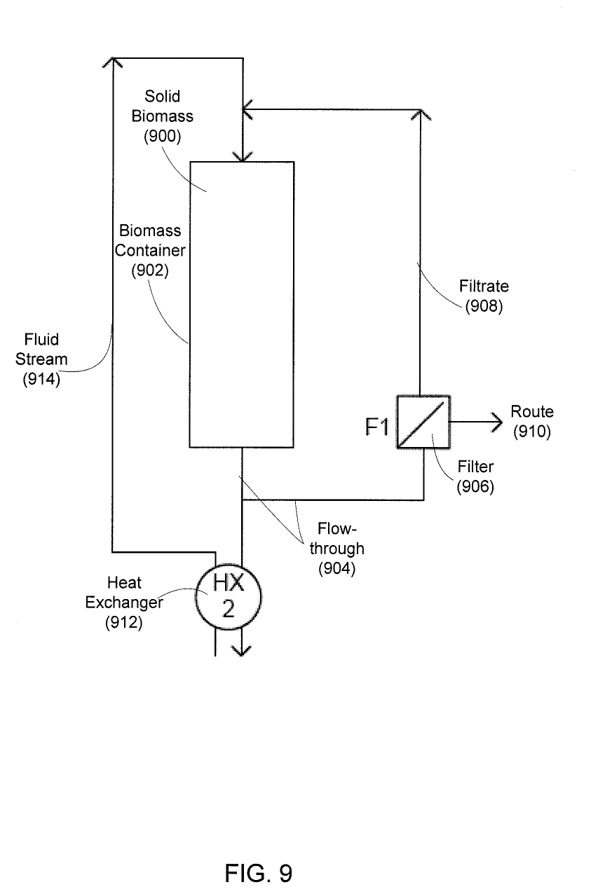

In another embodiment, a heat exchanger may be placed before the filter. FIG. 9 shows liquid flowing through solid biomass 900 that is present in a biomass container 902. Flow-through liquid 904 is a liquid mixture, containing water and solubilized biomass component(s), that exits the biomass container 902. In one aspect, flow-though liquid 904 is directed to filter 906. Filter 906 retains a portion of biomass from the flow-though liquid 904 and elutes the remainder of the flow-through liquid 904, as filtrate 908. Filtrate 908 is recycled to biomass container 902. In another aspect, flow-through liquid 904 is directed to heat exchanger 912. After passing through heat exchanger 912, flow-through liquid 904 exchanges heat with incoming fluid stream 914. Fluid stream 914 is recycled to biomass container 902. Also, components retained on filter 906 may be collected via route 910.

### Example 5

### Improved Biomass Recovery Using Multiple Biomass Containers (or Beds) with Flow-Through Pretreatment

The following nonlimiting example teaches by way of illustration, not by limitation, a process for improved biomass recovery using multiple biomass containers with flow-through pretreatment. For example, utilization of multiple pretreatment reaction vessels allows loading, or unloading, of one reaction vessel simultaneously while another biomass container is being processed. Utilization of two or more beds for holding solids permits efficient processing.

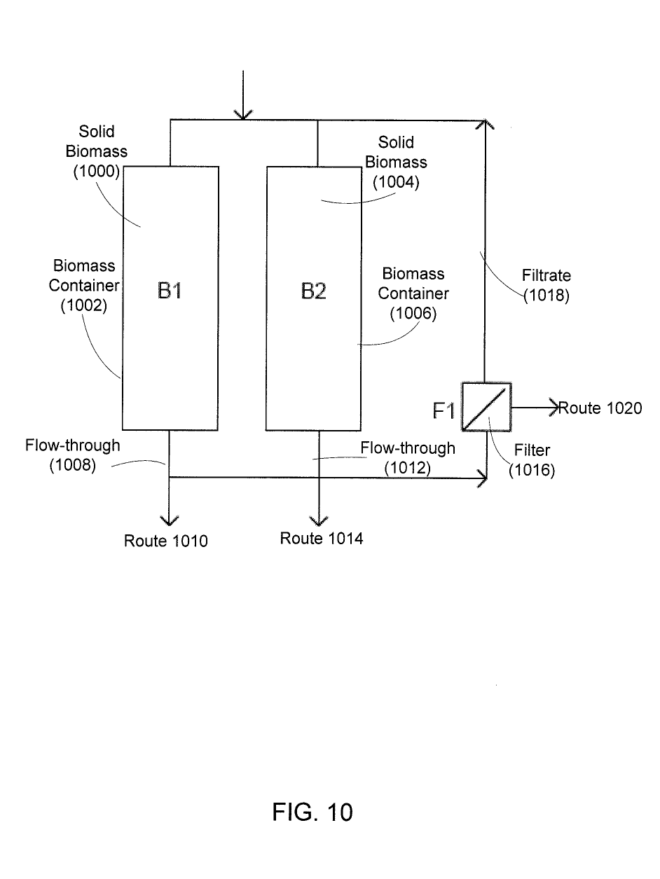

FIG. 10 shows a flow-through pretreatment using multiple reaction vessels. Solid biomass 1000 is located in biomass container 1002, whereas solid biomass 1004 is located in biomass container 1006. Reactor effluent 1008 is a liquid mixture, containing water and solubilized biomass component(s), that exits the reaction vessel 1002, whereas flow-through liquid 1012 is a liquid mixture, containing water and solubilized biomass component(s), which exits the reaction vessel 1006. In one aspect, flow-though liquid 1008 is directed to filter 1016. In another aspect, flow-though liquid 1012 is directed to filter 1016. Filter 1016 retains a portion of biomass from the flow-though liquid 1008 or flow-through liquid 1012 and elutes the remainder, as filtrate 1018. Also, components retained on filter 1016 may be collected via route 1020.

In one embodiment, reaction vessel 1002 is loaded while reaction vessel 1006 is being utilized.

In one embodiment, two reaction vessels each contain solid materials, such as wet wood chips or grasses. One reaction vessel is used for flow-through pretreatment. At the end of the pretreatment cycle, the liquid from the reaction vessel is used to flood the second biomass container that contains solid materials, such as wet wood chips or grasses, and preheat the biomass, thereby reducing overall water and energy usage. In various embodiments, movement of hot liquid from one reaction vessel to another biomass container involves mechanisms such as mechanical dewatering or expelling hot process liquid via compressed gases or water.

### Example 6

### Improved Biomass Recovery Using an Intermediate Processing Vessel with Flow-Through Pretreatment

The following nonlimiting example teaches by way of illustration, not by limitation, a process for improved biomass recovery using flow-through pretreatment and recycle with an intermediate vessel to accumulate and process liquid. Utilization of an intermediate vessel improves process flexibility and offers improved features.

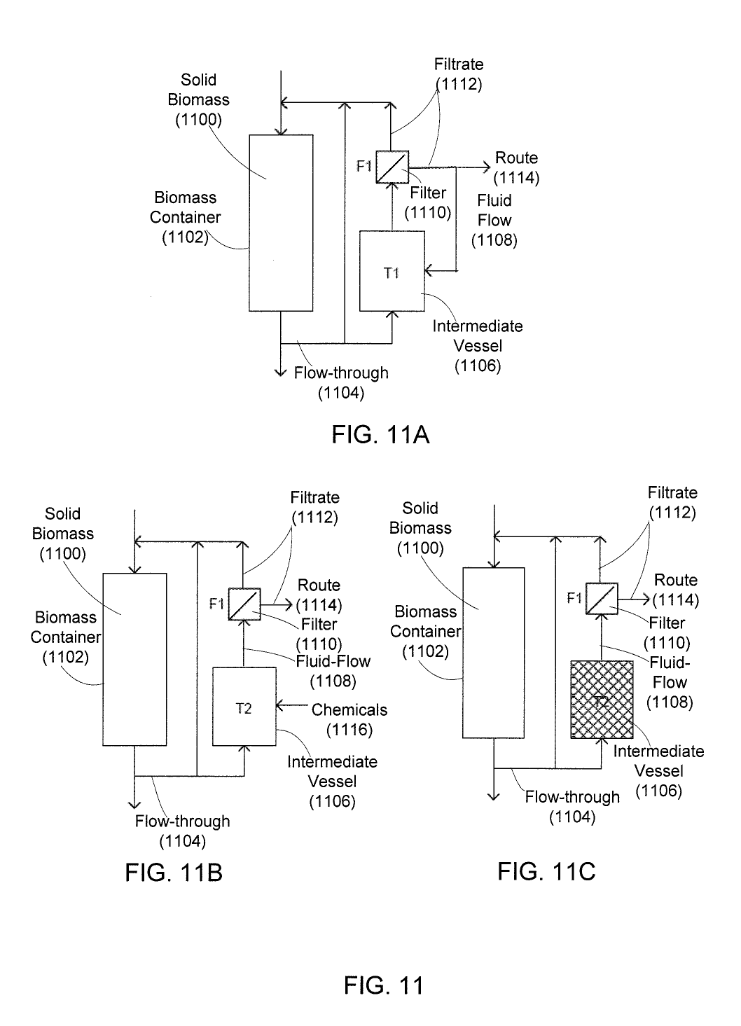

FIG. 11 shows flow-through pretreatment using an intermediate processing vessel. In FIG. 11A, solid biomass 1100 is located in reaction vessel 1102. Flow-through liquid 1104 is a liquid mixture, containing water and solubilized biomass component(s), which exits reaction vessel 1102. In one aspect, flow-though liquid 1104 is recycled to reaction vessel 1102. In another aspect, flow-though liquid 1104 is directed to intermediate vessel 1106. Fluid exiting the intermediate vessel 1106, fluid-flow 1108, is directed to filter 1110. Filter 1110 retains a portion of biomass from fluid flow 1108 and elutes the remainder, as filtrate 1112. In one aspect, filtrate 1112 exits via route 1114. In another aspect, filtrate 1112 is directed to intermediated vessel 1106. In another aspect, filtrate 1112 is directed to reaction vessel 1102.

FIG. 11B shows flow-through pretreatment using an intermediate vessel wherein chemicals 1116 are added to the intermediate vessel 1106. In one embodiment, chemicals are added to intermediate vessel 1106 to catalyze reactions. In another embodiment, dilute acid is added to intermediate vessel 1106 to depolymerize soluble oligosaccharides. In another embodiment, dilute caustic acid is added to intermediate vessel 1106 to break bonds between phenolic and carbohydrate molecules. In one embodiment, buffers are added to intermediate vessel 1106 to stabilize the solution facilitating stabilization for extended time and avoiding undesirable reactions. In one example, chemicals are added to a fluid stream resulting in the independence of reaction time on fluid flow through the biomass container 1102.

FIG. 11C shows flow-through pretreatment using an intermediate vessel 1106 that contains chemical catalysts. In one embodiment, chemicals within intermediate vessel 1106 react with molecules present in flow-through 1104.

The disclosed methods and systems may be modified without departing from the scope hereof It should be noted that the matter contained in the above description or shown in the accompanying drawings should be interpreted as illustrative and not in a limiting sense. The following claims are intended to cover all generic and specific features described herein, as well as all statements of the scope of the present method and system and reasonable variations thereof, which, as a matter of language, might be said to fall therebetween.

What is claimed is:

1. A method for pretreating a biomass, comprising the steps of:
(a) allowing an effective amount of a liquid to pass through the biomass, said biomass being held in a vessel, wherein at least one component of the biomass dissolves in said liquid and exits said vessel in the form of an effluent;
(b) allowing said effluent to pass through a filter, wherein more than 50% by weight of said at least one component in said effluent is retained by said filter as a retentate while the rest of the effluent passes through the filter forming a filtrate; and
(c) allowing the filtrate to flow back and pass through the biomass.

2. The method of claim 1, wherein the steps of (a)-(c) are repeated for n cycles, n being an integer between 1 and 50.

3. The method of claim 2, further comprising the step of converting the at least one component retained by the filter into ethanol.

4. The method of claim 2, wherein the temperature of the liquid in step (a) is between 120° C. and 240° C.

5. The method of claim 2, wherein the temperature of the liquid in step (a) of a repeating cycle is at least 1° C. higher than the temperature of the liquid in step (a) of the cycle immediately prior to said repeating cycle.

6. The method of claim 2, wherein the temperature of the liquid in step (a) of a repeating cycle is between 5° C. and 10° C. higher than the temperature of the liquid in step (a) of the cycle immediately prior to said repeating cycle.

7. The method of claim 1, wherein the filter has an average pore size of less than 2 nm.

8. The method of claim 1, wherein the filter comprises ceramic material.

9. The method of claim 1, wherein the at least one component is a carbohydrate having a molecule weight of less than 1,000 daltons.

10. A system for pretreating a material, said system comprising:
(a) a vessel for holding said material, said vessel having an inlet and an outlet, wherein said inlet allows for the infusion of a liquid into said vessel, and said outlet allows for said liquid to exit the vessel forming an effluent, (b) a filtering means operably connected to the outlet of said vessel, wherein said filtering means is configured to retain at least one component in the effluent while allowing a portion of said effluent to pass through said filtering means forming a filtrate; and
(c) a conveying means for transporting the filtrate to the inlet of said vessel.

11. The system of claim 10, wherein said material is a biomass.

12. The system of claim 11, wherein the at least one component of said biomass is dissolved in the effluent.

13. The system of claim 11, wherein the at least one component is a carbohydrate molecule having a molecule weight of less than 1,000 daltons.

14. The system of claim 11, wherein the at least one component is a carbohydrate molecule having a molecule weight of less than 500 daltons.

15. The system of claim 11 further comprising a fast operation valve for discharging solid biomass from the vessel.

16. The system of claim 11, wherein the filtering means comprises a nanoporous membrane having a pore size of 2 nm or smaller

17. The system of claim 11, wherein the filtering means comprises a nanoporous membrane, said nanoporous membrane being capable of functioning at a temperature higher than 120° C.

18. The system of claim 11, wherein the filtering means comprises a ceramic membrane.

19. The system of claim 11, further comprising a first heating means for increasing the temperature inside the vessel, said first heating means being located inside the vessel.

20. The system of claim 11, further comprising a second heating means for increasing the temperature of the filtrate, said second heating means being located outside the vessel.

21. The system of claim 11 further comprising a heating means for increasing the temperature of said biomass inside said vessel, said heating means being a steam injector configured to inject steam into said vessel.

22. The system of claim 11 further comprising a heat exchanging means, wherein said heat exchanging means is configured to recover heat from liquid exiting said vessel and to provide the recovered heat to the liquid entering the vessel.

23. A method for pretreating a biomass, said method comprising the step of:
(a) loading said biomass into the system of claim 11,
(b) allowing an effective amount of a liquid to pass through said biomass, wherein at least one component of said biomass dissolves at least partially in said liquid and exits said vessel in the form of an effluent;
(c) allowing said effluent to pass through said filtering means, wherein more than 50% by weight of said at least one component in said effluent is retained by said filtering means as a retentate while the rest of the effluent passes through the filtering means forming a filtrate; and
(d) allowing said filtrate to flow back and pass through the biomass in said vessel.

24. The method of claim 23, wherein the steps of (b)-(d) are repeated for n cycles, n being an integer between 1 and 50.
